(19) United States
(12) Patent Application Publication
(10) Pub. No.: US 2012/0251027 A1
(43) Pub. Date: Oct. 4, 2012

(54) METHODS AND DEVICES FOR MAKING AND USING CAGES FOR BEARING ASSEMBLIES

(75) Inventor: Kenneth Lee Pottebaum, Lakeville, MN (US)

(73) Assignee: Seagate Technology LLC

(21) Appl. No.: 13/079,089

(22) Filed: Apr. 4, 2011

(51) Int. Cl. F16C 33/38

(52) U.S. Cl. 384/523

(57) ABSTRACT

In certain embodiments, an apparatus includes a cage positioned between an inner race and an outer race. The cage includes a plurality of ball pockets for receiving balls and a grease pocket configured to substantially prevent a solid portion of a semi-solid lubricant from contacting the balls.

### SUMMARY

Various embodiments of the present invention are generally directed to devices and methods for making and using cages for bearing assemblies.

In certain embodiments, an apparatus includes a cage positioned between an inner race and an outer race. The cage includes a plurality of ball pockets for receiving balls and a grease pocket configured to substantially prevent a solid portion of a semi-solid lubricant from contacting the balls.

### BRIEF DESCRIPTION OF THE DRAWINGS

FIG. 1 provides a top view of an exemplary bearing assembly, in accordance with various embodiments of the present disclosure.

FIG. 2 provides a cross-section view of the exemplary bearing assembly of FIG. 1.

FIG. 3 provides a side plan view of a portion of an exemplary cage, illustrated as a straight ribbon for simplicity, in accordance with various embodiments of the present disclosure.

FIG. 4 provides a top view of the exemplary cage of FIG. 3.

FIG. 5 provides a side plan view of portion of an exemplary cage, illustrated as a straight ribbon for simplicity, in accordance with various embodiments of the present disclosure.

FIG. 6 provides a side plan view of a portion of an exemplary cage, illustrated as a straight ribbon for simplicity, in accordance with various embodiments of the present disclosure.

FIG. 7 provides a side view of the exemplary cage of FIG. 6.

FIG. 8 provides a side plan view of a portion of an exemplary cage, illustrated as a straight ribbon for simplicity, in accordance with various embodiments of the present disclosure.

FIG. 9 provides a side plan view of a portion of an exemplary cage, illustrated as a straight ribbon for simplicity, in accordance with various embodiments of the present disclosure.

FIG. 10 provides an isometric view of an exemplary bearing assembly in accordance with various embodiments of the present disclosure.

FIG. 11 provides a cross-section view of an exemplary bearing assembly, in accordance with various embodiments of the present disclosure.

### DETAILED DESCRIPTION

Bearing assemblies support various kinds of rotating parts. In use, bearing assemblies may be used in applications that require full 360-degree rotation, while other applications may limit bearing assemblies' motion to a small pivot or rotation range. In small pivot range applications, lubricants used in bearing assemblies may pile up and cause problems at the outer range of the pivot range. For example, in some hard disk drive applications, a bearing assembly is connected to an arm assembly and rotates in small pivot ranges to move the arm from an inside radius of a disk and past the outer radius of the disk in an unloaded state. If lubricant piles up at or in between the inner radius and the unloaded state, the bearing assembly may have difficulties rotating through the lubricant piles. Similarly, in other examples, implementing a bearing assembly that has too few ball bearings may encourage lubricant issues. Various embodiments of the present disclosure describe bearing assemblies that mitigate various lubricant issues in bearing assemblies.

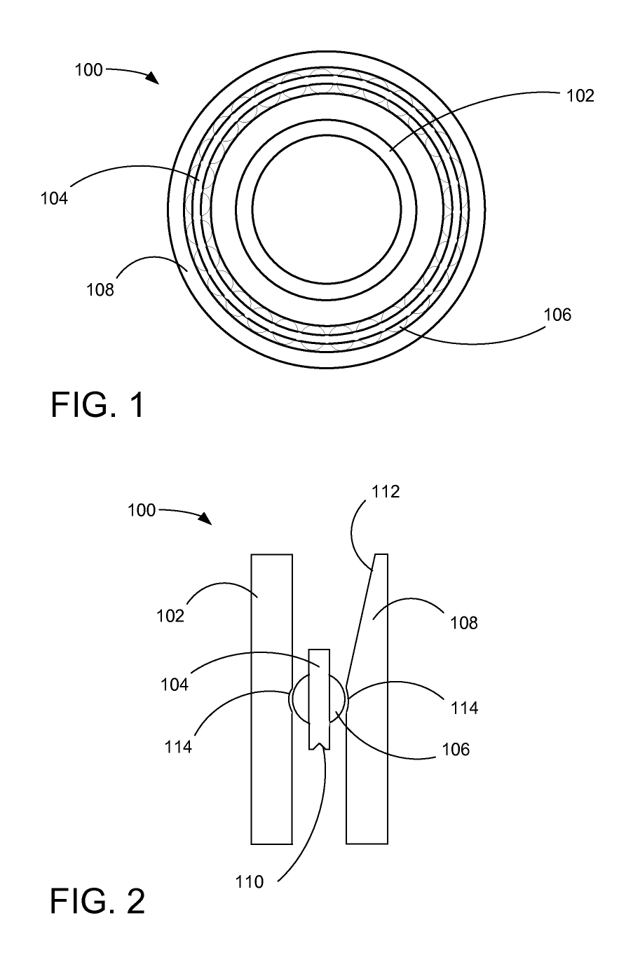

FIG. 1 provides a top view of a bearing assembly 100, which can be used to support various kinds of rotating parts. The bearing assembly 100 includes an inner race 102, cage 104, balls 106, and outer race 108. The inner race 102 and outer race 108 surround the cage 104, which is configured to retain the balls 106 so that the balls 106 can roll freely in between the races 102 and 108. The number of balls 106 can vary depending on the application.

As shown in FIG. 2, the cage 104 includes a grease pocket 110, which is configured to hold a lubricant. The outer race 108 can optionally include a shoulder 112, shown in FIG. 2 as a reduced shoulder, which can be configured for any suitable manufacturing and assembly method. Both the inner race 102 and outer race 108 includes raceways 114.

The grease pocket 110 can be of any suitable shape for holding a lubricant, which lubricates the balls. In certain embodiments, the lubricant is a semi-solid lubricant, which can include a liquid portion and a solid portion. In use, the semi-solid lubricant is disposed in the grease pocket 110. The grease pocket 110 is configured to prevent the solid portion of the semi-solid lubricant from contacting the balls so that the balls are lubricated by the liquid portion of the lubricant. More specifically, the grease pockets may be configured to permit the liquid portion of the lubricant to wick away from the solid portion, thus lubricating the balls with the liquid portion.

The number of balls and therefore ball pockets can vary depending on the application. For example, when the bearing assembly is used in an application that limits bearing assembly motion to a small pivot range, the pivot range may dictate the number of balls provided to avoid problems associated with lubricant piles forming in between ball wear-paths. These lubricant piles can cause the bearing assembly to get stuck because a device utilizing the bearing assembly may not have enough power or torque to rotate through the lubricant piles. For these applications, the number of balls provided can be enough so that the ball wear-paths overlap, thereby avoiding lubricant build-up or piles. Alternatively, the balls can be arranged so that fewer lubricant piles are created between ball wear-paths.

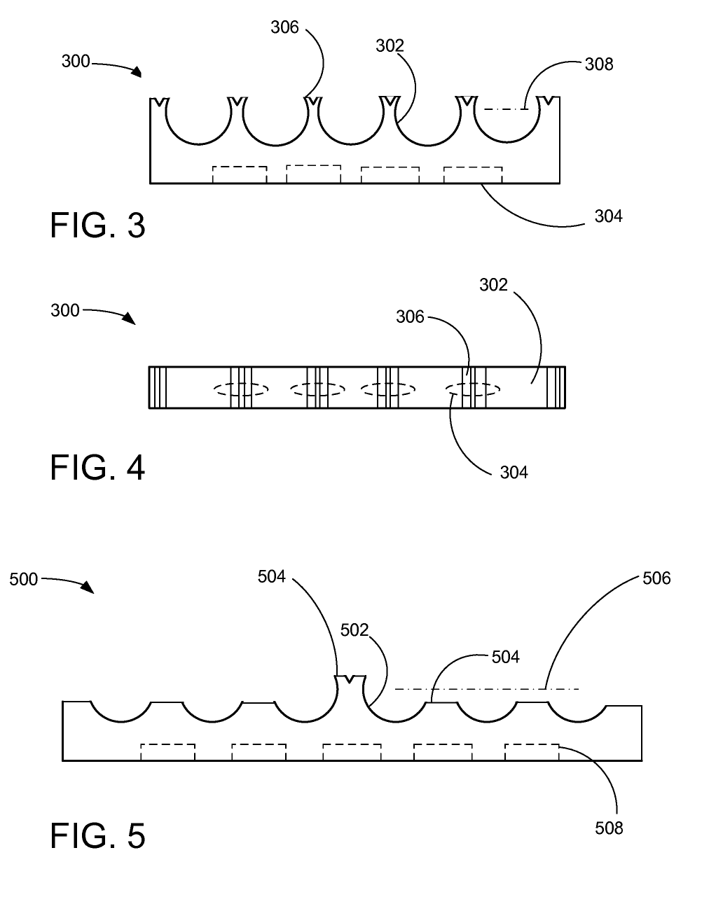

FIG. 3 is a side view of a portion of a cage 300 having ball pockets 302 and grease pockets 304. The ball pockets 302 can have fingers 306 for retaining balls (not shown) in the ball pockets 302. As shown in FIG. 3, the fingers 306 can extend above a centerline 308 of the balls. However, the fingers 306 may also extend below the centerline 308. FIG. 4 is a top view of the cage 300 and shows the grease pockets 304 as discrete pockets on the bottom of the cage 300. The grease pockets 304 can be of any suitable shape for holding a lubricant and are configured to prevent a solid portion of a semi-solid lubricant from contacting the balls so that the balls are lubricated by the liquid portion of the lubricant.

As shown in FIG. 5, a cage 500 is configured with ball pockets 502 arranged in groups that sit close together so that ball wear-paths overlap and lubricant piles are created in between the groups of balls—instead of in between each ball. The cage 500 has fingers 504 extending above a centerline 506 of the balls. In addition, the cage 500 includes fingers 504 that do not extend above the centerline 506. The cage 500 also includes grease pockets 508 positioned in the bottom of the cage 500. The grease pockets 508 are configured to prevent a solid portion of a semi-solid lubricant from contacting the balls so that the balls are lubricated by the liquid portion of the lubricant

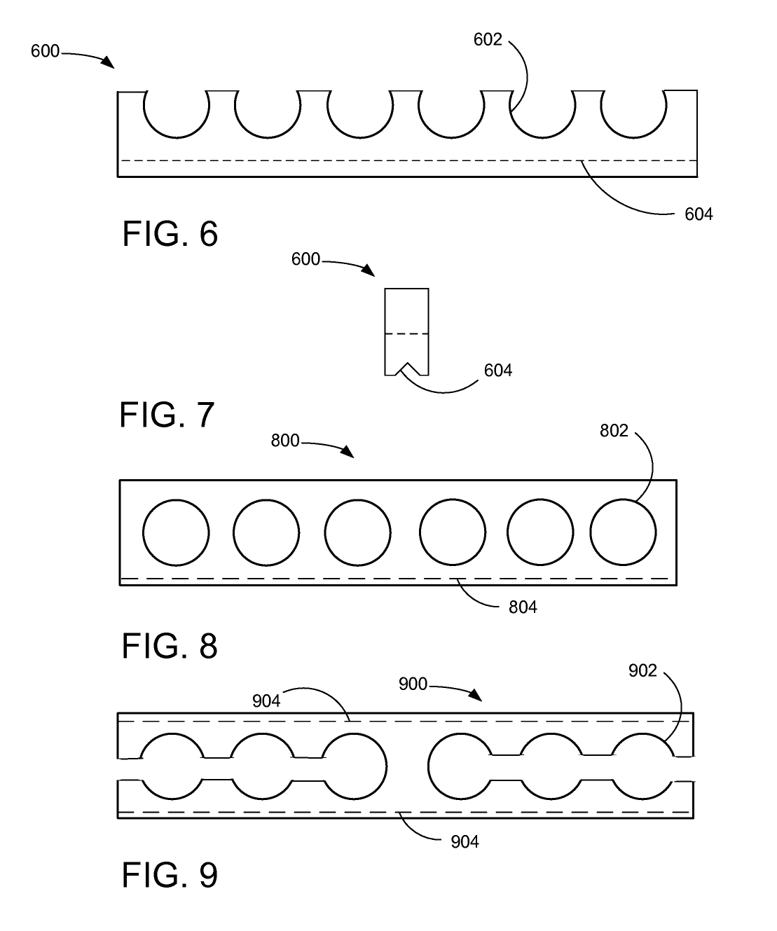

FIG. 6 is a front view of a portion of a cage 600, which includes ball pockets 602 and a grease pocket 604. The ball pockets 602 are arranged an equal distance from each other. FIG. 7 shows the cage 600 where the grease pocket 604 is a V-shaped groove. The grease pocket 604 can extend along the bottom of the cage 600 and can be of any suitable shape for retaining a lubricant. The grease pocket 604 is configured to prevent a solid portion of a semi-solid lubricant from contacting the balls so that the balls are lubricated by the liquid portion of the lubricant.

FIG. 8 is a front view of a portion of a cage 800, which includes ball pockets 802 and a grease pocket 804. The ball pockets 802 completely surround a portion of each of the balls (not shown) and are positioned an equal distance from each other. The grease pocket 804 can extend along the bottom of the cage 800. The grease pocket 804 is configured to prevent a solid portion of a semi-solid lubricant from contacting the balls so that the balls are lubricated by the liquid portion of the lubricant.

FIG. 9 is a front view of a portion of a cage 900, which includes ball pockets 902 and grease pockets 904. The ball pockets 902 are arranged in groups that sit close together so that ball wear-paths overlap and fewer lubricant piles are created. As shown in FIG. 9, the ball pockets 902 do not completely surround each of the balls and instead have a passage in between each of the balls in the group. The grease pockets 904 are positioned at the top and bottom of the cage 900. The grease pockets 904 are configured to prevent a solid portion of a semi-solid lubricant from contacting the balls so that the balls are lubricated by the liquid portion of the lubricant.

Although various embodiments disclose specific arrangements and configurations of a cage's ball pockets and grease pockets, it is to be understood that the details of the structure and function is illustrative only and the details may be modified and optimized, for example, for improved performance and manufacturability.

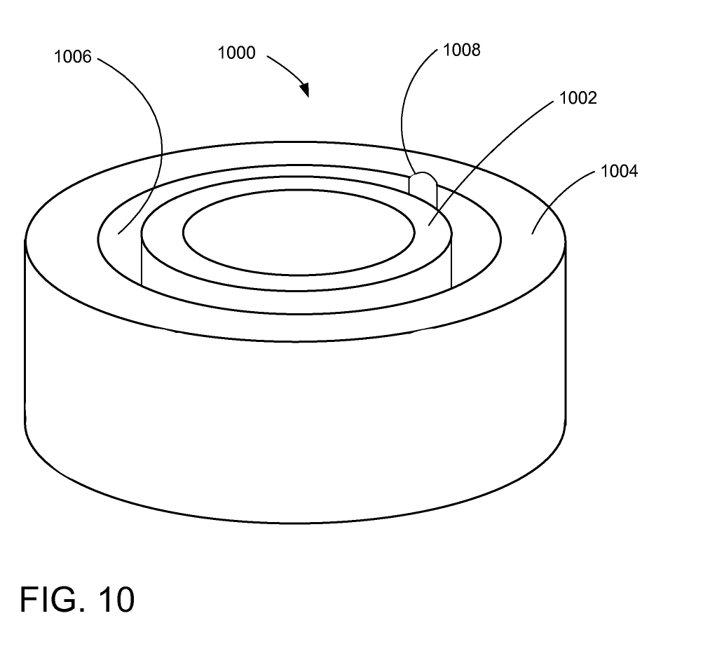

FIG. 10 is an isometric view of a bearing assembly 1000 having an inner race 1002 and an outer race 1004. The outer race 1004 has a shoulder 1006 and a feeder slot 1008 for inserting balls into the bearing assembly 1000. During assembly, the inner race 1002 and the outer race 1004 are centered. Then, the balls are inserted into the feeder slot 1008. As the balls are inserted, the balls are distributed around the inner race 1002 and outer race 1004 to make room for the next ball to be inserted. After the balls have been inserted, a cage (not shown) is inserted between the inner race 1002 and the outer race 1004. A lubricant can be added to the bearing assembly 1000.

Another assembly method includes machining an outer race's shoulder so that balls can be placed in between an inner race and an outer race without requiring a feeder slot. The balls are inserted into a cage before the cage is inserted between centered races. After inserting the cage, a lubricant can be added to the bearing assembly. This method may require the use of a fixture to keep the balls, cage, and races together until the bearing is preloaded.

Another assembly method includes machining an outer race's shoulder. Then, with the races centered, balls are placed in the outer race's reduced shoulder. The outer race is heated and thermally expands, providing the clearance necessary for the balls to drop in positioned between the races. Once cooled, the outer race contracts and the balls are retained between the races. A cage can be inserted between the races over the balls. A lubricant can be added to the bearing assembly.

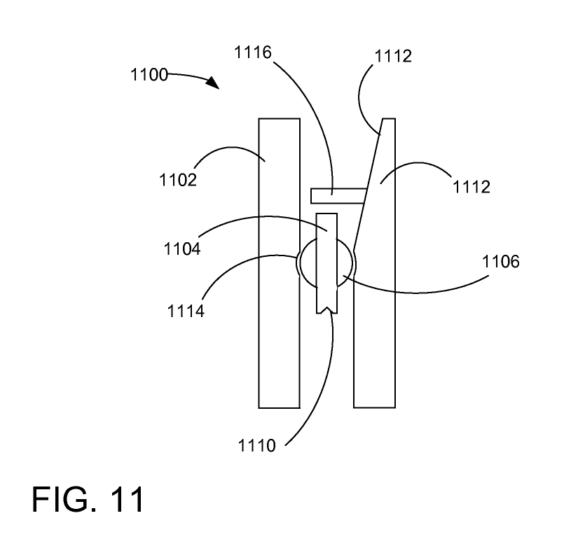

As shown in FIG. 11, a bearing assembly 1100 includes an inner race 1102, a cage 1104, balls 1106, outer race 1108, grease pocket 1110, reduced shoulder 1112, raceways 1114, and shield 1116. The inner race 1102 and outer race 1108 surround the cage 1104, which is configured to retain the balls 1106 so that the balls 1106 can roll freely in between the races 1102 and 1108 in the raceways 1114. The number of balls 1106 can vary depending on the application. The cage 1104 includes a grease pocket 1110. The grease pocket 1110 is configured to prevent a solid portion of a semi-solid lubricant from contacting the balls 1106 so that the balls 1106 are lubricated by the liquid portion of the lubricant.

During assembly, the races 1102 and 1108 are centered and the cage 1104 and balls 1106 are inserted between the races 1102 and 1108. The shield 1116 restricts the motion of the balls 1106 in the cage 1104 in between the races 1102 and 1108 without the need for an extra fixture. The shield 1116 can be held on the inner race 1102 or outer race 1108, for example, by a press fit or held by a c-clamp.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. An apparatus comprising:
a cage positioned between an inner race and an outer race, the cage including a plurality of ball pockets for receiving balls and a grease pocket configured to substantially prevent a solid portion of a semi-solid lubricant from contacting the balls.

2. The apparatus of claim 1, wherein the ball pockets partially enclose the balls.

3. The apparatus of claim 2, wherein the ball pockets include fingers extending below a centerline of the balls.

4. The apparatus of claim 2, wherein the ball pockets include fingers extending above a centerline of the balls.

5. The apparatus of claim 1, wherein the grease pocket is a groove.

6. The apparatus of claim 1, further comprising a plurality of grease pockets.

7. The apparatus of claim 1, wherein the cage includes at least 29 ball pockets.

8. The apparatus of claim 1, wherein the apparatus is a hard disk drive.

9. A method comprising:
providing a cage having a plurality of ball pockets for receiving balls and a grease pocket configured to substantially prevent a solid portion of a semi-solid lubricant from contacting the balls; and
positioning the cage in between an inner race and an outer race.

10. The method of claim 9, further comprising:
inserting the balls into the outer race.

11. The method of claim 9, further comprising:
inserting the balls into the cage.

12. The method of claim 9, further comprising:
inserting the semi-solid lubricant into the grease pockets, wherein a liquid portion of the semi-solid lubricant wicks away from the solid portion if the semi-solid lubricant; and
lubricating the balls with the liquid portion of the semi-solid lubricant.

13. The method of claim 9, further comprising:
rotating the cage to eliminate lubricant piles positioned between the ball pockets.

14. The method of claim 9, further comprising:
inserting the balls through a feeder slot.

15. The method of claim 9, further comprising:
heating the outer race;
inserting the balls into the outer race; and
cooling the outer race to position the balls in between the inner race and the outer race.

16. A cage for a bearing assembly, the cage comprising:
a plurality of ball pockets configured to received balls; and
a grease pocket for receiving a semi-solid lubricant, the grease pocket positioned on a bottom side of the cage.

17. The cage of claim 16, wherein the plurality of ball pockets are positioned on a top side of the cage, the ball pockets including fingers for retaining the balls.

18. The cage of claim 16, wherein the grease pocket is a groove.

19. The cage of claim 16, wherein the cage is installed in a bearing assembly in a hard disk drive.

20. The cage of claim 16, wherein the grease pocket is configured to substantially prevent a solid portion of a semi-solid lubricant from contacting the balls.
